(19) United States
(12) Patent Application Publication
(10) Pub. No.: US 2026/0339694 A1
(43) Pub. Date: Oct. 29, 2026

(54) VIRTUAL MACHINE RUNNING METHOD, STORAGE MEDIUM AND ELECTRONIC DEVICE

(71) Applicant: XG TECH PTE. LTD., Singapore (SG)

(72) Inventors: Tao LIN, Singapore (SG); Zhou CHEN, Singapore (SG); Jie DENG, Singapore (SG); Junhao GAO, Singapore (SG); Xinzhi TAO, Singapore (SG)

(73) Assignee: XG TECH PTE. LTD., Singapore (SG)

(21) Appl. No.: 19/724,337

(22) Filed: Jun. 29, 2026

(30) Foreign Application Priority Data
Jan. 15, 2026 (CN) 202610057857.X

(51) Int. Cl. G06F 9/455; G06F 11/1446

(52) U.S. Cl. CPC G06F 9/45558; G06F 11/1469; G06F 2009/45575; G06F 2009/45583

(57) ABSTRACT

Disclosed are a virtual machine running method, a storage medium and an electronic device. The method includes: in response to at least one virtual machine being in a running termination state, determining, by a virtual machine controller, a first image running memory and a first image backup memory pre-allocated for the virtual machine, when a virtual machine restart instruction is received; copying, by the virtual machine controller, a virtual machine image stored in the first image backup memory to the first image running memory; and executing, by the virtual machine controller, a virtual machine recovery instruction to trigger a jump to a kernel entry address of the first image running memory so as to resume running of the virtual machine.

### CROSS-REFERENCE TO RELATED APPLICATION

The present disclosure claims priority to Chinese Patent Application No. 202610057857.X filed on Jan. 15, 2026, which is incorporated herein by reference in its entirety.

### TECHNICAL FIELD

The present disclosure relates to the field of embedded virtualization technology, and more particularly, to a virtual machine running method, a storage medium and an electronic device.

### BACKGROUND

In an embedded virtualization scenario, in order to support normal startup and restart of a virtual machine, it is necessary to load a virtual machine image from a storage medium into a virtual machine memory before the virtual machine runs.

In the related art, it is necessary to deploy a privileged virtual machine and non-privileged virtual machines into a system. During system restart, a bootloader loads virtual machine images from a storage medium to virtual machine memories. When a non-privileged virtual machine restarts, the privileged virtual machine is required to load the virtual machine image for the non-privileged virtual machine from the storage medium to the virtual machine memory. As such, the restart of the non-privileged virtual machine needs to rely on the privileged virtual machine, but the restart of the privileged virtual machine cannot be supported. Therefore, the normal operation of the non-privileged virtual machine may be affected by the privileged virtual machine, making it impossible to achieve independent restart of virtual machines.

Accordingly, there is an urgent need for a virtual machine loading method to achieve independent restart among virtual machines.

### SUMMARY

To solve the above technical problems, the present disclosure provides a virtual machine running method, apparatus, and device, so as to achieve independent restart among virtual machines without relying on a privileged virtual machine.

In a first aspect of the present disclosure, there is provided a virtual machine running method, comprising:
in response to at least one virtual machine being in a running termination state, determining, by a virtual machine controller, a first image running memory and a first image backup memory pre-allocated for the virtual machine, when a virtual machine restart instruction is received;
copying, by the virtual machine controller, a virtual machine image stored in the first image backup memory to the first image running memory; and
executing, by the virtual machine controller, a virtual machine recovery instruction to trigger a jump to a kernel entry address of the first image running memory so as to resume running of the virtual machine.

In a second aspect of the present disclosure, there is provided a virtual machine running apparatus, comprising: a first determination module, configured to, in response to at least one virtual machine being in a running termination state, determine, by a virtual machine controller, a first image running memory and a first image backup memory pre-allocated for the virtual machine, when a virtual machine restart instruction is received;
a first copy module, configured to copy, by the virtual machine controller, a virtual machine image stored in the first image backup memory to the first image running memory; and
a first startup module, configured to execute, by the virtual machine controller, a virtual machine recovery instruction to trigger a jump to a kernel entry address of the first image running memory so as to resume running of the virtual machine.

In a third aspect of the present disclosure, there is provided an electronic device, comprising: a processor; a memory for storing instructions executable by the processor; and the processor is configured to read the executable instructions from the memory and execute the instructions to implement the virtual machine running method described in the first aspect.

In a fourth aspect of the present disclosure, embodiments provide a computer program product, wherein when instructions in the computer program product are executed by a processor, the virtual machine running method proposed in the embodiments of the first aspect of the present disclosure is executed.

The technical solution provided by the present disclosure, after a virtual machine stops running, first determines, by a virtual machine controller (hypervisor), an image backup memory and a virtual machine running memory pre-allocated for the virtual machine according to a received virtual machine restart instruction, and copies the virtual machine image stored in the image backup memory to the virtual machine running memory, and then executes a virtual machine recovery instruction through the hypervisor to resume running of the virtual machine. That is, through the present solution, in an embedded virtualization scenario, each time a virtual machine restarts, it is not necessary for a privileged virtual machine to load the virtual machine image from a storage medium to the virtual machine running memory; instead, the virtual machine controller loads the virtual machine image from the image backup memory to the virtual machine running memory. Therefore, the restart of the virtual machine does not need to rely on the privileged virtual machine, that is, it is not needed that a privileged virtual machine is deployed in the system, thereby achieving independent restart of virtual machines. Compared with conventional solutions that require deploying a privileged virtual machine, the present solution does not require deploying a privileged virtual machine, thus reducing the number of system components and lowering resource overhead of embedded devices.

### BRIEF DESCRIPTION OF DRAWINGS

FIG. 1 is a schematic flowchart of a virtual machine running system according to an exemplary embodiment of the present disclosure.

FIG. 2 is a schematic flowchart of a virtual machine running method according to an exemplary embodiment of the present disclosure.

FIG. 3 is a schematic flowchart of a virtual machine running method according to another exemplary embodiment of the present disclosure.

FIG. 4A is a schematic diagram of an image copying process according to an exemplary embodiment of the present disclosure.

FIG. 4B is a schematic diagram of an image copying process according to another exemplary embodiment of the present disclosure.

FIG. 5 is a schematic flowchart of a virtual machine running method according to yet another exemplary embodiment of the present disclosure.

FIG. 6 is a schematic flowchart of a virtual machine running method according to still another exemplary embodiment of the present disclosure.

FIG. 7 is a schematic diagram of an image loading process according to an exemplary embodiment of the present disclosure.

FIG. 8 is a schematic flowchart of a virtual machine running method according to still another exemplary embodiment of the present disclosure.

FIG. 9 is a schematic diagram of an image loading process according to another exemplary embodiment of the present disclosure.

FIG. 10 is a schematic structural diagram of a virtual machine running apparatus according to an exemplary embodiment of the present disclosure.

FIG. 11 is a structural diagram of an electronic device according to an exemplary embodiment of the present disclosure.

### DETAILED DESCRIPTION OF THE EMBODIMENTS

In order to explain the present disclosure, the exemplary embodiments of the present disclosure will be described in detail below with reference to the accompanying drawings. Apparently, the described embodiments are merely a part, not all, of the embodiments of the present disclosure. It should be understood that the present disclosure is not limited by the exemplary embodiments.

It should be noted that, unless otherwise specifically stated, the relative arrangements, numerical expressions, and numerical values of the components and steps set forth in these embodiments do not limit the scope of the present disclosure.

### Application Overview

As mentioned above, in the related art, it is necessary to deploy both a privileged virtual machine and non-privileged virtual machines into a system. During system startup, a bootloader loads respective virtual machine images from a storage medium to corresponding virtual machine memories. When a non-privileged virtual machine restarts, the privileged virtual machine is required to load the virtual machine image for the non-privileged virtual machine from the storage medium to the virtual machine memory. As such, the restart of the non-privileged virtual machine needs to rely on the privileged virtual machine, but the above method cannot support the restart of the privileged virtual machine. Therefore, the normal operation of the non-privileged virtual machine may be affected by the privileged virtual machine, making it impossible to achieve independent restart of virtual machines.

Based on the above technical problems, the technical solution provided by the present disclosure, after a virtual machine stops running, first determines, by a virtual machine controller (hypervisor), an image backup memory and a virtual machine running memory pre-allocated for the virtual machine according to a received virtual machine restart instruction, and copies the virtual machine image stored in the image backup memory to the virtual machine running memory, and then executes a virtual machine recovery instruction through the hypervisor to resume running of the virtual machine. That is, through the present solution, in an embedded virtualization scenario, each time a virtual machine restarts, it is not necessary for a privileged virtual machine to load the virtual machine image from a storage medium to the virtual machine running memory; instead, the virtual machine controller loads the virtual machine image from the image backup memory to the virtual machine running memory. Therefore, the restart of the virtual machine does not need to rely on the privileged virtual machine, i.e., the system does not need to deploy a privileged virtual machine, thereby achieving independent restart of virtual machines. Compared with conventional solutions that require deploying a privileged virtual machine, the present solution does not require deploying a privileged virtual machine, thus reducing the number of system components and lowering resource overhead of embedded devices.

Moreover, the present solution loads images through memory-level “image backup memory”, which is faster than loading from a storage medium, thereby improving the efficiency of virtual machine restart.

### Exemplary System

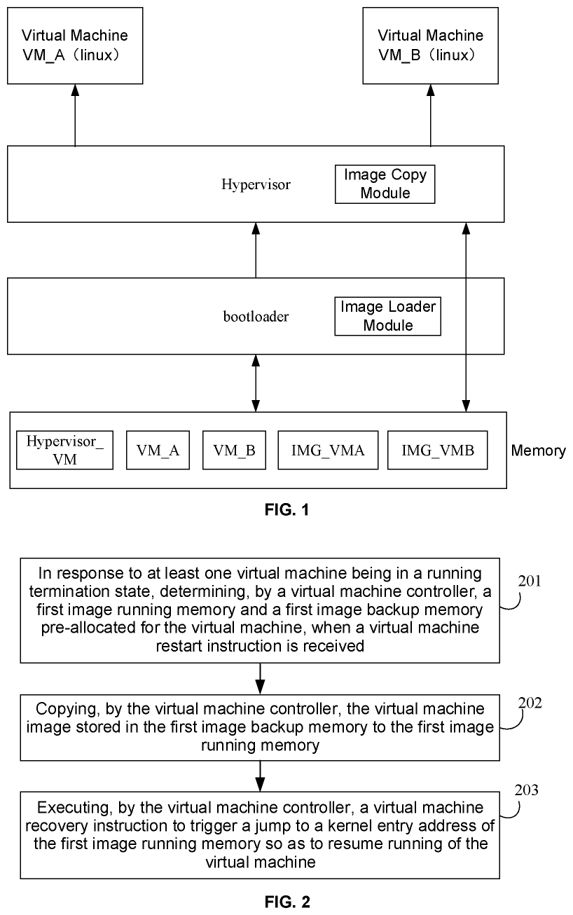

FIG. 1 is a schematic flowchart of a virtual machine running system according to an exemplary embodiment of the present disclosure. The system includes virtual machine VM_A and virtual machine VM_B, a virtual machine controller (hypervisor), a bootloader, and hardware memory. Both virtual machine VM_A and virtual machine VM_B are Linux systems.

Illustratively, as shown in FIG. 1, VM_A in the memory represents a first image running memory allocated for virtual machine VM_A, IMG_VMA in the memory represents a first image backup memory allocated for virtual machine VM_A, VM_B in the memory represents a first image running memory allocated for virtual machine VM_B, IMG_VMB in the memory represents a first image backup memory allocated for virtual machine VM_B, and Hypervisor_VM in the memory represents a second image running memory allocated for the virtual machine controller.

Illustratively, as shown in FIG. 1, the above bootloader may provide an image loader module responsible for loading respective virtual machine images and the hypervisor image from the storage medium. The hypervisor is responsible for creating and managing one or more virtual machines, and the hypervisor may provide an image copy module responsible for copying respective virtual machine images to support normal startup operation and restart of virtual machines. A complete virtual machine image includes a kernel image, a device tree file, and an initial memory filesystem.

In some examples, the image loader module in the bootloader may be used to load the virtual machine image for virtual machine VM_A from the storage medium to IMG_VMA, and to load the virtual machine image for virtual machine VM_B from the storage medium to IMG_VMB. The image copy module in the hypervisor may also be used to copy the virtual machine image for virtual machine VM_A from IMG_VMA to VM_A, and to copy the virtual machine image for virtual machine VM_B from IMG_VMB to VM_B.

As such, virtual machine VM_A may be created by the hypervisor based on the virtual machine image for VM_A, and VM_A may be normally started and run on VM_A (i.e., the first image running memory). After virtual machine VM_A stops running, the virtual machine image for virtual machine VM_A (e.g., the kernel image, the device tree file, and the initial memory filesystem) is re-copied from IMG_VMA to VM_A by the hypervisor to restart virtual machine VM_A. After virtual machine VM_B stops running, the operation may be resumed in a manner similar to that of virtual machine VM_A described above.

In some other examples, the image loader module in the bootloader may be used to load the virtual machine image for virtual machine VM_A from the storage medium to VM_A, and to load the virtual machine image for virtual machine VM_B from the storage medium to VM_B. Since the initial memory filesystem in the virtual machine image is configured not to be released after being decompressed at runtime, the image copy module in the hypervisor may be used to copy a partial virtual machine image from VM_A to IMG_VMA, and to copy a partial virtual machine image from VM_B to IMG_VMB.

As such, virtual machine VM_A may be created by the hypervisor based on the virtual machine image for VM_A, and VM_A may be normally started and run on VM_A (i.e., the first image running memory). After virtual machine VM_A stops running, a partial virtual machine image for virtual machine VM_A (e.g., the kernel image and the device tree file) is re-copied from IMG_VMA to VM_A by the hypervisor to restart virtual machine VM_A. After virtual machine VM_B stops running, the operation may be resumed in a manner similar to that of virtual machine VM_A described above.

For the virtual machine running system provided by the present disclosure, only a virtual machine controller (hypervisor) and ordinary virtual machines are deployed, and image backup memories for backing up virtual machine images are provided, without a privileged virtual machine being deployed. Through the present solution, in an embedded virtualization scenario, each time a virtual machine restarts, it is not necessary for a privileged virtual machine to load the virtual machine image from a storage medium to the virtual machine running memory; instead, the virtual machine controller loads the virtual machine image from the image backup memory to the virtual machine running memory. Therefore, the restart of the virtual machine does not need to rely on the privileged virtual machine, thereby achieving independent restart of virtual machines. Compared with conventional solutions that require deploying a privileged virtual machine, the present solution does not require deploying a privileged virtual machine, thus reducing the number of system components and lowering resource overhead of embedded devices.

### Exemplary Method

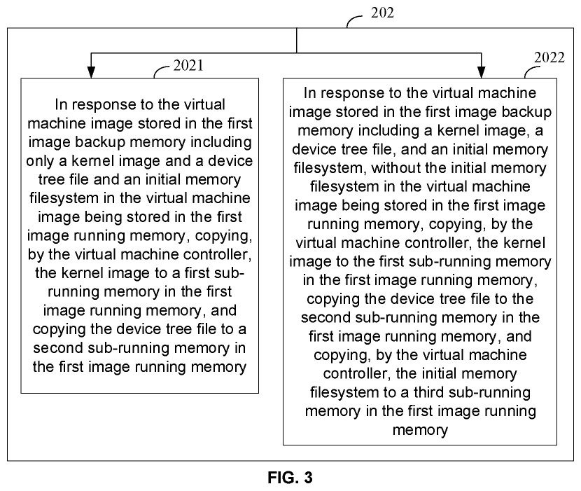

FIG. 2 is a schematic flowchart of a virtual machine running method according to an exemplary embodiment of the present disclosure. This embodiment may be applied to an electronic device. As shown in FIG. 2, the method includes the following steps:

Step 201: In response to at least one virtual machine being in a running termination state, determining, by a virtual machine controller, a first image running memory and a first image backup memory pre-allocated for the virtual machine, when a virtual machine restart instruction is received.

In some examples, the virtual machine switching from a running state to a running termination state may generally include the following situations: (1) the virtual machine being triggered to execute a normal shutdown process and entering the running termination state by a user executing a shutdown command; (2) forcibly entering into termination due to an error crash of the virtual machine system; (3) forcibly terminating the running of the virtual machine by abnormal running of the virtual machine detected by the virtual machine controller; and (4) the virtual machine being instantly terminated due to a hardware failure (e.g., processor overheating). The above four situations are merely illustrative, and the embodiments of the present disclosure are not limited thereto.

In some embodiments, the above virtual machine restart instruction is a command or signal that triggers the virtual machine to resume from the running termination state to the running state (i.e., virtual machine restart). The above virtual machine restart instruction may be a restart instruction directly sent by a user or a system administrator through a management interface or a command-line tool (e.g., entering the command “reboot”), or may be a preset timed restart instruction, etc. When the virtual machine restart instruction carries a target virtual machine identifier, the virtual machine restart instruction is only used to restart the target virtual machine indicated by the target virtual machine identifier, and the target virtual machine may be a specific virtual machine or all virtual machines among the at least one virtual machine. When the virtual machine restart instruction does not carry any virtual machine identifier, the virtual machine restart instruction may be used to restart all virtual machines in the running termination state currently managed by the virtual machine controller.

In some embodiments, the above virtual machine controller (hypervisor), acting as an administrator with administrator privileges, may be used for resource allocation and scheduling of respective virtual machines. Through the virtual machine controller, multiple memory regions are partitioned from a physical memory, e.g., a Double Data Rate Synchronous Dynamic Random-Access Memory (DDR), and allocated to respective virtual machines as the corresponding first image running memories for the virtual machines; the first image running memory is used for running a virtual machine image. The hypervisor may also pre-allocate a corresponding first image backup memory for each virtual machine, and the first image backup memory is used for storing the virtual machine image loaded from the storage medium. As such, each virtual machine corresponds to a unique first image backup memory and first image running memory, and based on the above correspondence, the first image backup memory and the first image running memory corresponding to each virtual machine may be determined according to the virtual machine identifier of the at least one virtual machine in the running termination state. It can be understood that the size and location of the above first image running memory and first image backup memory are determined when the virtual machine is created, and these two memory regions are directly reused when the virtual machine restarts.

Step 202: Copying, by the virtual machine controller, the virtual machine image stored in the first image backup memory to the first image running memory.

In some embodiments, since the virtual machine images of the respective virtual machines are loaded from the storage medium to the corresponding first image backup memories during system startup, the respective first image backup memories store the corresponding virtual machine images in advance. Thus, when restarting a virtual machine, if the first image backup memory and the first image running memory corresponding to each virtual machine have been determined, the virtual machine image stored in the first image backup memory of each virtual machine may be copied to the corresponding first image running memory by the virtual machine controller (hypervisor) based on the identifier of each virtual machine.

Illustratively, assume that virtual machine A, virtual machine B, and virtual machine C are included. Based on the identifiers of the respective virtual machines, the hypervisor determines a first image running memory A′ and a first image backup memory A″ allocated for virtual machine A, a first image running memory B′ and a first image backup memory B″ allocated for virtual machine B, and a first image running memory C′ and a first image backup memory C″ allocated for virtual machine C. As such, based on the identifier of virtual machine A, the hypervisor copies the virtual machine image for virtual machine A stored in the first image backup memory A″ to the first image running memory A′; based on the identifier of virtual machine B, the hypervisor copies the virtual machine image for virtual machine B stored in the first image backup memory B″ to the first image running memory B′; and based on the identifier of virtual machine C, the hypervisor copies the virtual machine image for virtual machine C stored in the first image backup memory C″ to the first image running memory C′.

In some examples, a complete virtual machine image typically includes a kernel image (Kernel Image), an initial memory filesystem, and a device tree file (Device Tree Blob, DTB). For example, the initial memory filesystem may be an Initial RAM Disk (Initrd) or an Initial RAM Filesystem (initramfs). In one possible case, the virtual machine image stored in the first image backup memory is a complete image file; for example, the virtual machine image stored in the first image backup memory includes all of the Kernel Image, the Initrd, and the DTB. In another possible case, the virtual machine image stored in the first image backup memory is a partial image file; for example, the virtual machine image stored in the first image backup memory includes only the Kernel Image and the DTB. In the embodiments disclosed herein, only the Initrd, as an example of the initial memory filesystem, is described for illustrative purposes, which is not intended to be limited thereto.

Step 203: Executing, by the virtual machine controller, a virtual machine recovery instruction to trigger a jump to a kernel entry address of the first image running memory so as to resume running of the virtual machine.

In some examples, the above kernel entry address of the first image running memory is the start address for the kernel image (Kernel Image) in the virtual machine image. Through executing a virtual machine recovery instruction (e.g., vm_resume) by the hypervisor, the CPU context is initialized based on the kernel entry address for the Kernel Image, and then the CPU switches to the virtual machine mode, and jumps to the kernel entry address for the Kernel Image to start reading and executing instructions. The virtual machine kernel parses the DTB and mounts a real root filesystem based on the Initrd, thereby resuming running of the virtual machine. For detailed descriptions of the restart of the virtual machine, reference may be made to relevant descriptions in the related art, which will not be repeated herein.

It should be noted that, if the virtual machine image has not been updated, the above Steps 201 to 203 are directly executed to resume operation of the respective virtual machines when the virtual machine restarts. If the virtual machine image has been updated, Steps 205 to 207 described below need to be executed to re-create virtual machines and run the respective virtual machines when the virtual machine restarts. In addition, in the solution of the present disclosure, the virtual machine system needs to use a Linux system or a Linux-like system.

The technical solution provided by the present disclosure, after a virtual machine stops running, first determines, by a virtual machine controller (hypervisor), an image backup memory and a virtual machine running memory pre-allocated for the virtual machine according to a received virtual machine restart instruction, and copies the virtual machine image stored in the image backup memory to the virtual machine running memory, and then executes a virtual machine recovery instruction through the hypervisor to resume running of the virtual machine. That is, through the present solution, in an embedded virtualization scenario, each time a virtual machine restarts, it is not necessary for a privileged virtual machine to load the virtual machine image from a storage medium to the virtual machine running memory; instead, the virtual machine controller loads the virtual machine image from the image backup memory to the virtual machine running memory. Therefore, the restart of the virtual machine does not need to rely on the privileged virtual machine, that is, the system does not need to deploy a privileged virtual machine, thereby achieving independent restart of virtual machines. Compared with conventional solutions that require deploying a privileged virtual machine, the present solution does not require deploying a privileged virtual machine, thus reducing the number of system components and lowering resource overhead of embedded devices.

Moreover, the present solution loads images through memory-level “image backup memory”, which is faster than loading from a storage medium, thereby improving the efficiency of virtual machine restart.

In some embodiments, when creating a virtual machine, whether the initial memory filesystem in the virtual machine image stored in the first image running memory is retained without being released after decompression will result in different virtual machine images being copied from the first image backup memory to the first image running memory during the restart of the virtual machine. Based on this, as shown in FIG. 3, on the basis of the embodiment shown in FIG. 2, the above Step 202 may include the following steps:

Step 2021: In response to the virtual machine image stored in the first image backup memory including only a kernel image and a device tree file and an initial memory filesystem in the virtual machine image being stored in the first image running memory, copying, by the virtual machine controller, the kernel image to a first sub-running memory in the first image running memory, and copying the device tree file to a second sub-running memory in the first image running memory.

In some embodiments, when creating a virtual machine, if the initial memory filesystem in the virtual machine image stored in the first image running memory is retained without being released after decompression, the first image running memory still stores the initial memory filesystem. If the virtual machine is restarted, there is no need to copy the initial memory filesystem to the first image running memory again. As such, when the first image backup memory includes only the kernel image and the device tree file, it is only necessary to copy, by the virtual machine controller (hypervisor), the kernel image from the first image backup memory to the first sub-running memory in the first image running memory, and to copy the device tree file from the first image backup memory to the second sub-running memory in the first image running memory.

In some examples, the above first image backup memory may include a first sub-backup memory and a second sub-backup memory, in which the first sub-backup memory is used for storing the kernel image, and the second sub-backup memory is used for storing the device tree file. That is, in the above case, it is not necessary to reserve image backup memory for the Initrd, and it is only necessary to provide image backup memory for backing up the Kernel Image and the DTB for the respective virtual machines.

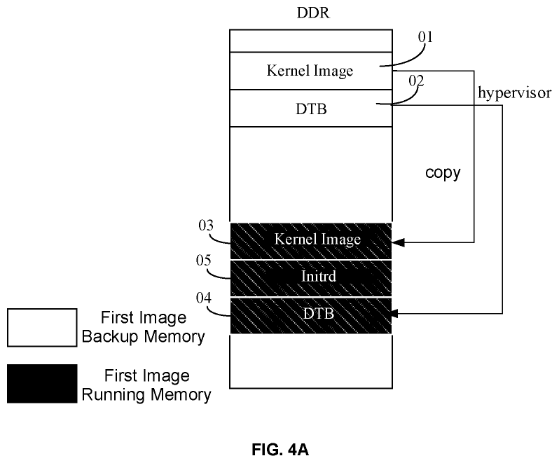

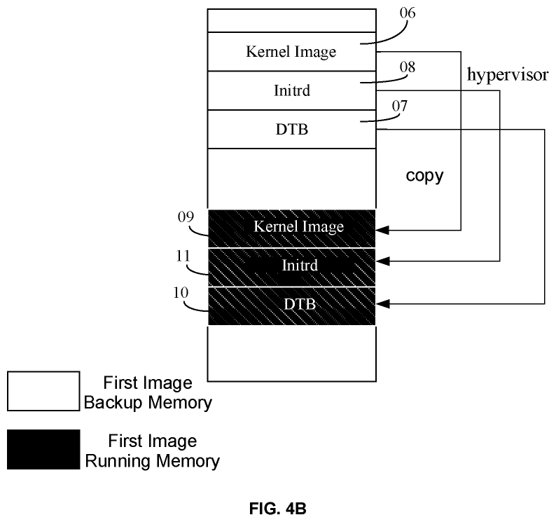

For example, as shown in FIG. 4A, the first image backup memory includes a first sub-backup memory 01 and a second sub-backup memory 02, in which the first sub-backup memory 01 stores the Kernel Image and the second sub-backup memory 02 stores the DTB. The first image running memory includes a first sub-running memory 03, a second sub-running memory 04, and a third sub-running memory 05. Since the third sub-running memory 05 stores the initial memory filesystem Initrd, when restarting the virtual machine, the hypervisor may copy the Kernel Image stored in the first sub-backup memory 01 to the first sub-running memory 03, and copy the DTB stored in the second sub-backup memory 02 to the second sub-running memory 04.

Step 2022: In response to the virtual machine image stored in the first image backup memory including a kernel image, a device tree file, and an initial memory filesystem, without the initial memory filesystem in the virtual machine image being stored in the first image running memory, copying, by the virtual machine controller, the kernel image to the first sub-running memory in the first image running memory, copying the device tree file to the second sub-running memory in the first image running memory, and copying, by the virtual machine controller, the initial memory filesystem to a third sub-running memory in the first image running memory.

In some embodiments, when creating a virtual machine, if the initial memory filesystem in the virtual machine image stored in the first image running memory has been released after decompression, the first image running memory no longer stores the initial memory filesystem. If the virtual machine is restarted, it is necessary to re-copy the initial memory filesystem to the first image running memory. Thus, when the first image backup memory also includes the initial memory filesystem, in addition to copying, by the virtual machine controller (hypervisor), the kernel image to the first sub-running memory in the first image running memory and copying the device tree file to the second sub-running memory in the first image running memory, it is also necessary to copy, by the virtual machine controller (hypervisor), the initial memory filesystem stored in the first image backup memory to the third sub-running memory in the first image running memory. That is, in the above case, it is necessary not only to provide image backup memory for backing up the Kernel Image and the DTB for the respective virtual machines, but also to reserve image backup memory for the Initrd.

In some examples, the above first image backup memory may include a first sub-backup memory, a second sub-backup memory, and a third sub-backup memory, in which the first sub-backup memory stores the kernel image, the second sub-backup memory stores the device tree file, and the third sub-backup memory includes the initial memory filesystem. That is, in the above case, it is necessary to provide all of image backup memories for backing up the Kernel Image, the DTB, and the Initrd respectively for the respective virtual machines.

For example, as shown in FIG. 4B, the first image backup memory includes a first sub-backup memory 06, in which the Kernel Image is stored, a second sub-backup memory 07, in which the DTB is stored, and a third sub-backup memory 08, in which the Initrd is stored. The first image running memory includes a first sub-running memory 09, a second sub-running memory 10, and a third sub-running memory 11. Since the third sub-running memory 11 does not store the initial memory filesystem Initrd, when restarting the virtual machine, the hypervisor may copy the Kernel Image stored in the first sub-backup memory 06 to the first sub-running memory 09, copy the DTB stored in the second sub-backup memory 07 to the second sub-running memory 10, and copy the Initrd stored in the third sub-backup memory 08 to the third sub-running memory 11.

Based on the above embodiments, since, in response to the virtual machine image stored in the first image backup memory including only a kernel image and a device tree file and an initial memory filesystem in the virtual machine image being stored in the first image running memory, the virtual machine controller may copy the kernel image to the first sub-running memory in the first image running memory and copy the device tree file to the second sub-running memory in the first image running memory, or, in response to the first image backup memory also including the initial memory filesystem without the initial memory filesystem in the virtual machine image being stored in the first image running memory, the virtual machine controller may also copy the initial memory filesystem to the third sub-running memory in the first image running memory; therefore, on the one hand, on-demand allocation and isolated storage of respective parts of the image are achieved, avoiding redundant memory occupation caused by overall copying, and on the other hand, image copying can be flexibly adapted according to the two states of the virtual machine image composition and the running memory, thereby significantly shortening the virtual machine restart time by reducing the amount of data to be copied.

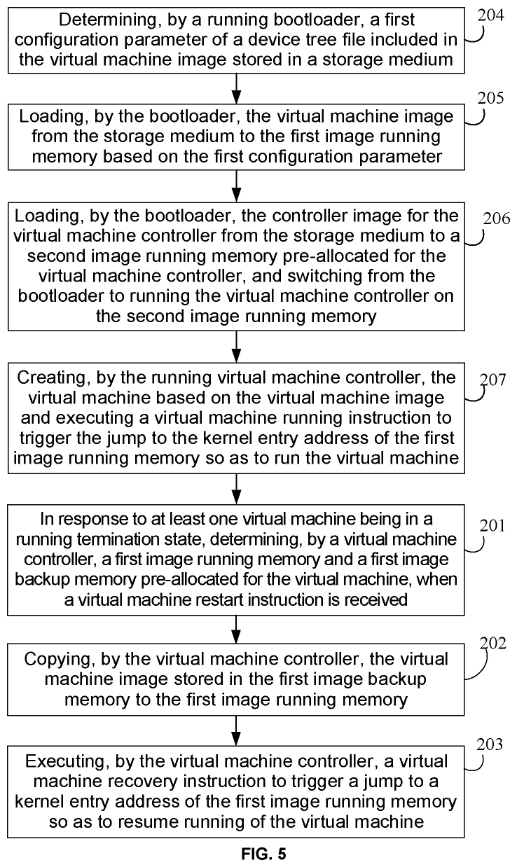

In some embodiments, during the system startup phase, the respective virtual machine images and the controller image for the virtual machine controller may be loaded from the storage medium by the bootloader, and the respective virtual machines may be created and managed by the virtual machine controller. Based on this, as shown in FIG. 5, on the basis of the embodiment shown in FIG. 2, before Step 201, the virtual machine running method provided by the embodiments of the present disclosure may further include the following steps:

Step 204: Determining, by a running bootloader, a first configuration parameter of a device tree file included in the virtual machine image stored in a storage medium.

The first configuration parameter is used to configure a release state of an initial memory filesystem included in the virtual machine image after being decompressed at runtime.

In some examples, the above bootloader is the first piece of software that runs when the system starts, and is used to access the storage medium and load the virtual machine images of the respective virtual machines from the storage medium to the corresponding memories. The above bootloader is mainly applied in embedded scenarios; for example, the above bootloader may be a Universal Bootloader (U-Boot) or a lightweight embedded bootloader, etc.

Illustratively, the above storage medium is an external physical device that stores virtual machine images and the controller image for the virtual machine controller. For example, the storage medium may be an embedded MultiMediaCard (eMMC), a Secure Digital Card (SD), etc. The embodiments of the present disclosure are not limited thereto.

In some embodiments, when the virtual machine system is a Linux system, the virtual machine Linux system may retain the memory occupied by the initrd image without releasing it after decompressing the initrd image. As such, before system startup, the DTB in the virtual machine image stored in the storage medium may be pre-modified to add a retain_initrd boot parameter therein, and this boot parameter is used as the first configuration parameter. During the system startup phase, the bootloader invokes a storage medium driver to access the storage medium, locates the storage location of the virtual machine image, identifies the device tree file (DTB) from the storage location, and parses the identified DTB file to extract the first configuration parameter.

Illustratively, when the first configuration parameter is a first preset configuration value, it indicates that the initial memory filesystem is configured to enable release after being decompressed at runtime; when the first configuration parameter is a second preset configuration value, it indicates that the initial memory filesystem is configured to disable release after being decompressed at runtime.

Step 205: Loading, by the bootloader, the virtual machine image from the storage medium to the first image running memory based on the first configuration parameter.

In some embodiments, since different first configuration parameters configure different release states of the initial memory filesystem after being decompressed at runtime, the manner in which the bootloader loads the virtual machine image from the storage medium to the first image running memory based on different first configuration parameters differs. When the first configuration parameter configures the initial memory filesystem to enable release after being decompressed at runtime, the bootloader may first load the virtual machine image from the storage medium to the first image backup memory, and then the hypervisor may copy the virtual machine image from the first image backup memory to the first image running memory. When the first configuration parameter configures the initial memory filesystem to disable release after being decompressed at runtime, the bootloader may directly load the virtual machine image from the storage medium to the first image running memory. Details may be referred to the detailed descriptions in the following embodiments, and the embodiments of the present disclosure are not limited thereto.

In some embodiments, when the first configuration parameter configures the initial memory filesystem to enable release after being decompressed at runtime, as shown in FIG. 6, on the basis of the embodiment shown in FIG. 2, the above Step 205 may specifically include the following steps:
Step 2051: In response to the first configuration parameter configuring the initial memory filesystem to enable release after being decompressed at runtime, loading, by the bootloader, the virtual machine image from the storage medium to the first image backup memory.

In some embodiments, for each virtual machine, when the first configuration parameter configures the initial memory filesystem to enable release after being decompressed at runtime, that is, the initial memory filesystem can actively release the running memory occupied by the initial memory filesystem after being decompressed into the running memory and completing its task during the boot process, for subsequent components (e.g., virtual machine images) to use, it is therefore necessary to reload the initial memory filesystem each time the virtual machine is started. Hence, during the system startup phase, the complete virtual machine image (including the kernel image, the device tree file, and the initial memory filesystem) is loaded from the storage medium to the dedicated first image backup memory by the bootloader. That is, the first image backup memory stores a complete virtual machine image including the initial memory filesystem, so that when subsequently creating, starting, or restarting a virtual machine, the complete virtual machine image including the initial memory filesystem can be copied from the first image backup memory to the dedicated first image running memory.

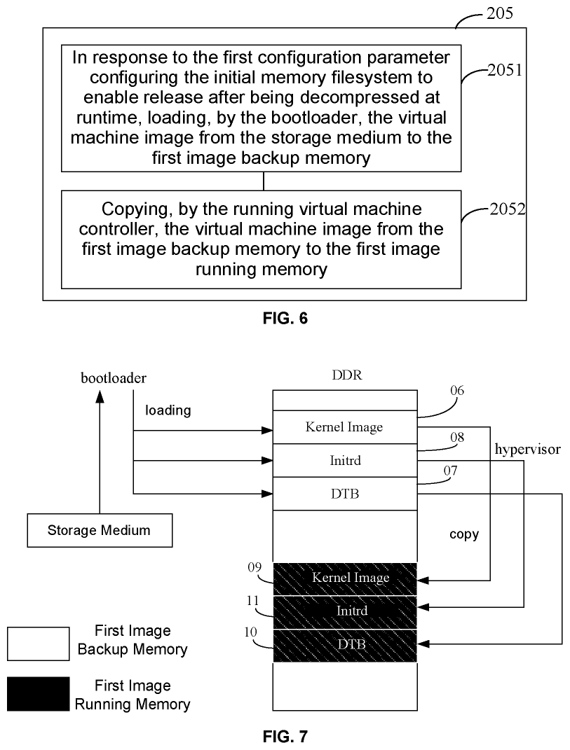

For example, as shown in FIG. 7, the first image backup memory includes a first sub-backup memory 06, a second sub-backup memory 07, and a third sub-backup memory 08; the first image running memory includes a first sub-running memory 09, a second sub-running memory 10, and a third sub-running memory 11. During the system startup phase, if the first configuration parameter configures the initial memory filesystem to enable release after being decompressed at runtime, the Kernel Image in the virtual machine image is loaded from the storage medium to the first sub-backup memory 06, the DTB in the virtual machine image is loaded from the storage medium to the second sub-backup memory 07, and the Initrd in the virtual machine image is loaded from the storage medium to the third sub-backup memory 08 by the bootloader.

Step 2052: Copying, by the running virtual machine controller, the virtual machine image from the first image backup memory to the first image running memory.

In some embodiments, after loading the virtual machine image from the storage medium to the first image backup memory by the bootloader, the control is transferred from the bootloader to the hypervisor by executing Step 206 below to jump to the hypervisor for operation. Then, the above Step 2052 is executed, that is, the virtual machine image is copied from each first image backup memory to the corresponding first image running memory by the hypervisor.

In some embodiments, the above Step 2052 may specifically include: in response to the virtual machine image stored in the first image backup memory including a kernel image, a device tree file, and an initial memory filesystem, copying, by the virtual machine controller, the kernel image from the first image backup memory to a first sub-running memory in the first image running memory, copying the device tree file from the first image backup memory to a second sub-running memory in the first image running memory, and copying the initial memory filesystem from the first image backup memory to a third sub-running memory in the first image running memory.

In some examples, the above first image backup memory may be divided into a first sub-backup memory for storing the kernel image, a second sub-backup memory for storing the device tree file, and a third sub-backup memory for storing the initial memory filesystem. The kernel image is copied from the first sub-backup memory to the first sub-running memory, the device tree file is copied from the second sub-backup memory to the second sub-running memory, and the initial memory filesystem is copied from the third sub-backup memory to the third sub-running memory by the virtual machine controller (hypervisor).

For example, as shown in FIG. 7, during the system startup phase, the Kernel Image may be copied from the first sub-backup memory 06 to the first sub-running memory 09, the DTB may be copied from the second sub-backup memory 07 to the second sub-running memory 10, and the Initrd may be copied from the third sub-backup memory 08 to the third sub-running memory 11 by the hypervisor. As such, subsequently, at least one virtual machine may be created by the hypervisor.

Based on the above embodiments, since, in response to the first configuration parameter configuring the initial memory filesystem to enable release after being decompressed at runtime, the virtual machine image is loaded from the storage medium to the first image backup memory by the bootloader, and the virtual machine image is copied from the first image backup memory to the first image running memory by the running virtual machine controller; therefore, in the case where the initial memory filesystem is allowed to be released after decompression, image backup memory is provided for backing up the complete virtual machine image, thereby ensuring that the complete virtual machine image can be copied from the first image backup memory to the first image running memory to start or restart the virtual machine.

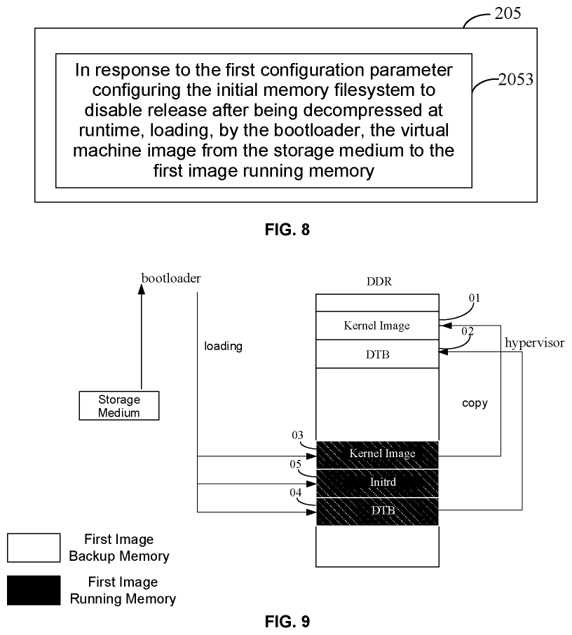

In some other embodiments, when the first configuration parameter configures the initial memory filesystem to disable release after being decompressed at runtime, as shown in FIG. 8, on the basis of the embodiment shown in FIG. 2, the above Step 205 may specifically include the following step:

Step 2053: In response to the first configuration parameter configuring the initial memory filesystem to disable release after being decompressed at runtime, loading, by the bootloader, the virtual machine image from the storage medium to the first image running memory.

In some examples, the virtual machine image stored in the above storage medium is a complete image file, i.e., the virtual machine image includes a kernel image, a device tree file, and an initial memory filesystem simultaneously. Therefore, the first image running memory may be divided into a first sub-running memory, a second sub-running memory, and a third sub-running memory, in which the first sub-running memory is used for storing the kernel image, the second sub-running memory is used for storing the device tree file, and the third sub-running memory is used for storing the initial memory filesystem. When the first configuration parameter configures the initial memory filesystem to disable release after being decompressed at runtime, the kernel image may be loaded from the storage medium to the first sub-running memory, the device tree file may be loaded from the storage medium to the second sub-running memory, and the initial memory filesystem may be loaded from the storage medium to the third sub-running memory by the bootloader. As such, the virtual machine image is loaded from the storage medium to the first image running memory by the bootloader.

For example, as shown in FIG. 9, the first image backup memory includes a first sub-backup memory 01 and a second sub-backup memory 02; the first image running memory includes a first sub-running memory 03, a second sub-running memory 04, and a third sub-running memory 05. During the system startup phase, if the first configuration parameter configures the initial memory filesystem to disable release after being decompressed at runtime, the Kernel Image in the virtual machine image is loaded from the storage medium to the first sub-running memory 03, the DTB in the virtual machine image is loaded from the storage medium to the second sub-running memory 04, and the Initrd in the virtual machine image is loaded from the storage medium to the third sub-running memory 05 by the bootloader.

Based on the above embodiments, since, in response to the first configuration parameter configuring the initial memory filesystem to disable release after being decompressed at runtime, the virtual machine image is loaded from the storage medium to the first image running memory by the bootloader, and then a virtual machine is created and started for operation based on the virtual machine image loaded to the first image running memory; therefore, it is not necessary to load the virtual machine image from the storage medium to the first image backup memory by the bootloader and then copy from the first image backup memory to the first image running memory, thereby simplifying the virtual machine creation and startup process during the system startup phase and shortening the time for a single startup of the virtual machine.

In some embodiments, the virtual machine running method provided by the embodiments of the present disclosure may further include the following step: before running the virtual machine, copying, by the running virtual machine controller, the virtual machine image from the first image running memory to the first image backup memory.

In order to ensure reloading after the virtual machine fails to load to the first image running memory or restart after the virtual machine abnormally stops, after the control is transferred from the bootloader to the virtual machine controller, since the initial memory filesystem is retained without being released after decompression, a partial virtual machine image (i.e., the kernel image and the device tree file) may also be copied from each first image running memory to the corresponding first image backup memory by the virtual machine controller.

In some embodiments, the above step of copying, by the running virtual machine controller, the virtual machine image from the first image running memory to the first image backup memory may specifically include: in response to the virtual machine image stored in the first image running memory including a kernel image, a device tree file, and an initial memory filesystem, copying, by the running virtual machine controller, the kernel image from the first image running memory to a first sub-backup memory in the first image backup memory, and copying the device tree file from the first image running memory to a second sub-backup memory in the first image backup memory.

In some embodiments, the first sub-running memory in the first image running memory is used for storing the kernel image, the second sub-running memory is used for storing the device tree file, and the third sub-running memory is used for storing the initial memory filesystem. Since the first configuration parameter configures the initial memory filesystem to disable release after being decompressed at runtime, after the kernel image, the device tree file, and the initial memory filesystem are respectively decompressed and complete their tasks, the kernel image and the device tree file will be released, while the initial memory filesystem will not be released. That is, the first sub-running memory and the second sub-running memory are released, while the third sub-running memory is occupied by the unreleased initial memory filesystem. Therefore, it is necessary to back up only the kernel image and the device tree file, i.e., the running virtual machine controller may copy the kernel image from the first sub-running memory in the first image running memory to the first sub-backup memory in the first image backup memory, and copy the device tree file from the second sub-running memory in the first image running memory to the second sub-backup memory in the first image backup memory. As such, compared with the manner of releasing the initial memory filesystem in the above embodiments, the manner of not releasing the initial memory filesystem adopted in this embodiment results in the first image backup memory occupying less memory space.

For example, as shown in FIG. 9, the first image backup memory includes a first sub-backup memory 01 and a second sub-backup memory 02; the first image running memory includes a first sub-running memory 03, a second sub-running memory 04, and a third sub-running memory 05. Since the initial memory filesystem is retained without being released after decompression, it is necessary to back up only the kernel image and the device tree file. Thus, before starting the virtual machine for operation, the Kernel Image may be copied from the first sub-running memory 03 to the first sub-backup memory 01, and the DTB may be copied from the second sub-running memory 04 to the second sub-backup memory 02 by the hypervisor.

Based on the above embodiments, before running the virtual machine, the kernel image may be copied from the first image running memory to the first sub-backup memory in the first image backup memory, and the device tree file may be copied from the first image running memory to the second sub-backup memory in the first image backup memory by the running virtual machine controller. Therefore, it is necessary to back up only the kernel image and the device tree file for the respective virtual machines, without backing up the initial memory filesystem, thereby occupying less image backup memory space and saving memory resources. Moreover, during normal startup operation and restart of the virtual machine, the hypervisor only needs to copy the kernel image and the device tree file, without copying the initial memory filesystem, resulting in better virtual machine startup performance.

Step 206: Loading, by the bootloader, the controller image for the virtual machine controller from the storage medium to a second image running memory pre-allocated for the virtual machine controller, and switching from the bootloader to running the virtual machine controller on the second image running memory.

In some embodiments, the above second image running memory may be a dedicated running memory pre-allocated for the virtual machine controller. As such, the bootloader determines, based on the identifier of the virtual machine controller, the second image running memory pre-allocated for the virtual machine controller. When the storage medium stores the controller image for the virtual machine controller, the bootloader may also load the controller image for the virtual machine controller from the storage medium to the second image running memory.

In some embodiments, the above switching from the bootloader to running the virtual machine controller on the second image running memory may be understood as: the bootloader executes a jump instruction to trigger the transfer of CPU control to the virtual machine controller, the CPU switches from the execution context of the bootloader to the execution context of the virtual machine controller, and the virtual machine controller code is executed at the entry address for the controller image in the second image running memory, thereby achieving the startup of the virtual machine controller.

Step 207: Creating, by the running virtual machine controller, the virtual machine based on the virtual machine image and executing a virtual machine running instruction to trigger the jump to the kernel entry address of the first image running memory so as to run the virtual machine.

In some examples, the above kernel entry address of the first image running memory is the start address for the kernel image (Kernel Image) in the virtual machine image. The virtual machine controller parses the DTB file in each virtual machine image to obtain hardware parameters (such as memory layout and peripheral base addresses), initializes the device tree file of the virtual machine, and creates a virtual machine control block to record the image path, running state, etc., so as to create at least one virtual machine. Thereafter, a virtual machine running instruction (e.g., vm_run) is executed by the virtual machine controller, the CPU context of the virtual machine is configured based on the start address for the Kernel Image, the CPU then switches to the virtual machine mode, thereby triggering the CPU to jump to the start address for the Kernel Image and start reading and executing instructions from that address. The virtual machine kernel parses the DTB and mounts a real root filesystem based on the Initrd, so as to normally start and run the respective virtual machines, thereby achieving independent startup of the respective virtual machines. For the specific implementation of the virtual machine creation and startup process, reference may be made to the detailed descriptions in the related art, which will not be repeated herein.

Based on the above embodiments, since the first configuration parameter of the device tree file included in the virtual machine image stored in the storage medium is determined by the running bootloader, and the virtual machine image is loaded from the storage medium to the first image running memory based on the first configuration parameter, meanwhile the controller image for the virtual machine controller is loaded to the second image running memory, and the operation is switched to the virtual machine controller running on the second image running memory, and the virtual machine controller creates the virtual machine based on the virtual machine image and executes a virtual machine running instruction to trigger the jump to the kernel entry address of the first image running memory so as to run the virtual machine; that is, the present solution is capable of dynamically determining the loading strategy based on the configuration parameter of the device tree file, thereby flexibly adapting to the memory layout differences of different embedded hardware and enhancing the compatibility and stability of the system startup process.

### Exemplary Apparatus

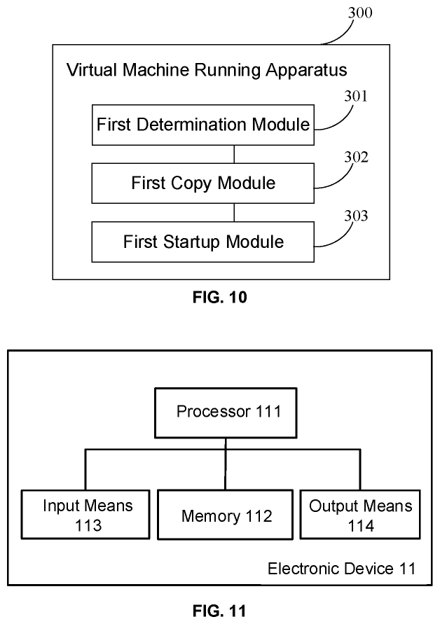

FIG. 10 is a schematic structural diagram of a virtual machine running apparatus according to an exemplary embodiment of the present disclosure. The apparatus may be disposed in a terminal device, a server, or other electronic device, or on an object such as a vehicle, to execute the virtual machine running method of any of the above embodiments of the present disclosure.

As shown in FIG. 10, the above apparatus 300 may include: a first determination module 301, which may be configured to, in response to at least one virtual machine being in a running termination state, determine, by a virtual machine controller, a first image running memory and a first image backup memory pre-allocated for the virtual machine, when a virtual machine restart instruction is received; a first copy module 302, which may be configured to copy, by the virtual machine controller, the virtual machine image stored in each of the first image backup memories to the first image running memory; and a first startup module 303, which may be configured to execute, by the virtual machine controller, a virtual machine recovery instruction to trigger a jump to a kernel entry address of the first image running memory so as to resume running of the virtual machine.

In one possible implementation, the above first copy module 302 may be specifically configured to: in response to the virtual machine image stored in the first image backup memory including only a kernel image and a device tree file and an initial memory filesystem in the virtual machine image being stored in the first image running memory, copy, by the virtual machine controller, the kernel image to a first sub-running memory in the first image running memory, and copy the device tree file to a second sub-running memory in the first image running memory.

In one possible implementation, the above first copy module 302 may be further specifically configured to: in response to the virtual machine image stored in the first image backup memory including a kernel image, a device tree file, and an initial memory filesystem, without the initial memory filesystem in the virtual machine image being stored in the first image running memory, copy, by the virtual machine controller, the kernel image to a first sub-running memory in the first image running memory, copying the device tree file to a second sub-running memory in the first image running memory, and copying the initial memory filesystem to a third sub-running memory in the first image running memory.

In one possible implementation, the above apparatus 300 may further include: a second determination module, which may be configured to determine, by a running bootloader, a first configuration parameter of a device tree file included in the virtual machine image stored in a storage medium, wherein the first configuration parameter is used for configuring a release state of an initial memory filesystem included in the virtual machine image after being decompressed at runtime; a first loading module, which may be configured to load, by the bootloader, the virtual machine image from the storage medium to the first image running memory based on the first configuration parameter; a second loading module, which may be configured to load, by the bootloader, the controller image for the virtual machine controller from the storage medium to a second image running memory pre-allocated for the virtual machine controller, and to switch from the bootloader to running the virtual machine controller on the second image running memory; and a second startup module, configured to create, by the running virtual machine controller, the virtual machine based on the virtual machine image and execute a virtual machine running instruction to trigger the jump to the kernel entry address of the first image running memory so as to run the virtual machine.

In one possible implementation, the above first loading module may be specifically configured to: in response to the first configuration parameter configuring the initial memory filesystem to enable release after being decompressed at runtime, load, by the bootloader, the virtual machine image from the storage medium to the first image backup memory; and copy, by the running virtual machine controller, the virtual machine image from the first image backup memory to the first image running memory.

In one possible implementation, the above first loading module may be specifically configured to: in response to the virtual machine image stored in the first image backup memory including a kernel image, a device tree file, and an initial memory filesystem, copy, by the virtual machine controller, the kernel image from the first image backup memory to a first sub-running memory in the first image running memory, copy the device tree file from the first image backup memory to a second sub-running memory in the first image running memory, and copy the initial memory filesystem from the first image backup memory to a third sub-running memory in the first image running memory.

In one possible implementation, the above first loading module may be specifically configured to: in response to the first configuration parameter configuring the initial memory filesystem to disable release after being decompressed at runtime, load, by the bootloader, the virtual machine image from the storage medium to the first image running memory.

In one possible implementation, the above apparatus 300 may further include: a second copy module, which may be configured to, before running the virtual machine, copy, by the running virtual machine controller, the virtual machine image from the first image running memory to the first image backup memory.

In one possible implementation, the above second copy module may be specifically configured to: in response to the virtual machine image stored in the first image running memory including a kernel image, a device tree file, and an initial memory filesystem, copy, by the running virtual machine controller, the kernel image from the first image running memory to a first sub-backup memory in the first image backup memory, and copy the device tree file from the first image running memory to a second sub-backup memory in the first image backup memory.

The beneficial technical effects corresponding to this exemplary apparatus embodiment may be referred to the corresponding beneficial technical effects in the above exemplary method section, which will not be repeated herein.

### Exemplary Electronic Device

FIG. 11 is a structural diagram of an electronic device according to an embodiment of the present disclosure, including at least one processor 111 and a memory 112.

The processor 111 may be a Central Processing Unit (CPU) or another form of processing unit having data processing capability and/or instruction execution capability, and may control other components in the electronic device 11 to perform desired functions.

The memory 112 may include one or more computer program products, and the computer program products may include various forms of computer-readable storage media, such as volatile memory and/or non-volatile memory. The volatile memory may include, for example, Random Access Memory (RAM) and/or cache. The non-volatile memory may include, for example, Read-Only Memory (ROM), a hard disk, a flash memory, etc. One or more computer program instructions may be stored on the computer-readable storage medium, and the processor 111 may run the one or more computer program instructions to implement the virtual machine running method of the various embodiments of the present disclosure described above and/or other desired functions.

In one example, the electronic device 11 may further include: an input means 113 and an output means 114, and these components are interconnected through a bus system and/or other forms of connection mechanisms (not shown).

The input means 113 may include various types of sensors, including but not limited to: a ranging sensor for detecting a distance between a target object and a vehicle; and an image sensor for collecting environmental information around the vehicle. In some examples, the input means may further include a pressure sensor for detecting seat pressure to determine whether there is a passenger and the position of the passenger; a temperature sensor for monitoring the temperature inside the cabin; a humidity sensor for monitoring the humidity inside the cabin to assist in adjusting the in-vehicle environment; an air quality sensor for monitoring the in-vehicle air quality, such as carbon dioxide and volatile organic compounds (VOCs); a light sensor for detecting the light intensity inside and outside the vehicle; an acceleration sensor for detecting changes in the acceleration of the vehicle; a distance sensor for detecting the distance between the vehicle and other objects; a touchscreen sensor for interaction with the vehicle infotainment system; a biometric sensor, such as fingerprint recognition and facial recognition; a heart rate monitor for monitoring the heart rate of the driver; a sound sensor for voice recognition and interaction to implement voice control functions; a seat sensor for monitoring the usage of the seat, such as whether the seat is occupied and the body size of the passenger; and a wireless communication sensor, such as Bluetooth and Wi-Fi, for connecting to smart devices to implement data transmission and remote control. In addition to the examples given above, the input means may further include more or fewer sensors, which will not be described in further detail herein.

The output means 114 may output various information or signals to other hardware or devices, and the other hardware or devices may include a display, an in-vehicle audio system, a seat, a window, a steering wheel, etc., as well as a communication network and a remote output means connected thereto, etc. The display may include a main driver display, a co-driver display, a rear-row display, and other different display screens. The in-vehicle audio system may include multiple loudspeakers disposed at different positions within the vehicle cabin, and the different display screens or loudspeakers may each operate independently.

Of course, for simplicity, only some of the components in the electronic device 11 related to the present disclosure are shown in FIG. 11, and components such as buses and input/output interfaces are omitted. In addition, depending on the specific application, the electronic device 11 may further include any other appropriate components.

### Exemplary Computer Program Product and Computer-Readable Storage Medium

In addition to the above methods and devices, the embodiments of the present disclosure may further provide a computer program product, including computer program instructions, which, when run by a processor, cause the processor to execute the steps in the virtual machine running method of the various embodiments of the present disclosure described in the above “Exemplary Method” section.

The computer program product may be written in program code for executing the operations of the embodiments of the present disclosure in any combination of one or more programming languages, including object-oriented programming languages such as Java, C++, etc., as well as conventional procedural programming languages such as “C” or similar programming languages. The program code may be executed entirely on a user computing device, partially on a user device, as a standalone software package, partially on a user computing device and partially on a remote computing device, or entirely on a remote computing device or server.

In addition, the embodiments of the present disclosure may also be a computer-readable storage medium having computer program instructions stored thereon, which, when run by a processor, cause the processor to execute the steps in the virtual machine running method of the various embodiments of the present disclosure described in the above “Exemplary Method” section.

The computer-readable storage medium may employ any combination of one or more readable media. The readable medium may be a readable signal medium or a readable storage medium. The readable storage medium may include, for example, but is not limited to, an electrical, magnetic, optical, electromagnetic, infrared, or semiconductor system, apparatus, or device, or any combination thereof. More specific examples (a non-exhaustive list) of the readable storage medium include: an electrical connection having one or more wires, a portable disk, a hard disk, Random Access Memory (RAM), Read-Only Memory (ROM), Erasable Programmable Read-Only Memory (EPROM or flash memory), optical fiber, a portable Compact Disc Read-Only Memory (CD-ROM), an optical storage device, a magnetic storage device, or any suitable combination thereof.

The basic principles of the present disclosure have been described above with reference to specific embodiments. However, the advantages, benefits, effects, etc. mentioned in the present disclosure are merely examples and not limitations, and should not be considered as being required by all embodiments of the present disclosure. In addition, the specific details disclosed above are merely for illustrative and explanatory purposes and are not limiting. The above details do not limit the present disclosure to necessarily adopting the above specific details for implementation.

Those skilled in the art may make various modifications and variations to the present disclosure without departing from the spirit and scope of the present application. As such, if these modifications and variations of the present application fall within the scope of the claims of the present disclosure and their equivalents, then the present disclosure is also intended to encompass these modifications and variations.

1. A virtual machine running method, comprising:
in response to at least one virtual machine being in a running termination state, determining, by a virtual machine controller, a first image running memory and a first image backup memory pre-allocated for the virtual machine, when a virtual machine restart instruction is received;
copying, by the virtual machine controller, a virtual machine image stored in the first image backup memory to the first image running memory; and
executing, by the virtual machine controller, a virtual machine recovery instruction to trigger a jump to a kernel entry address of the first image running memory so as to resume running of the virtual machine.

2. The method according to claim 1, wherein the copying, by the virtual machine controller, a virtual machine image stored in the first image backup memory to the first image running memory comprises:
in response to the virtual machine image stored in the first image backup memory comprising only a kernel image and a device tree file and an initial memory filesystem in the virtual machine image being stored in the first image running memory, copying, by the virtual machine controller, the kernel image to a first sub-running memory in the first image running memory, and copying the device tree file to a second sub-running memory in the first image running memory.

3. The method according to claim 1, wherein the copying, by the virtual machine controller, a virtual machine image stored in the first image backup memory to the first image running memory comprises:
in response to the virtual machine image stored in the first image backup memory comprising a kernel image, a device tree file, and an initial memory filesystem, without the initial memory filesystem in the virtual machine image being stored in the first image running memory, copying, by the virtual machine controller, the kernel image to a first sub-running memory in the first image running memory, copying the device tree file to a second sub-running memory in the first image running memory, and copying the initial memory filesystem to a third sub-running memory in the first image running memory.

4. The method according to claim 1, wherein before in response to at least one virtual machine being in a running termination state, determining, by a virtual machine controller, a first image running memory and a first image backup memory pre-allocated for the virtual machine, when a virtual machine restart instruction is received, the method further comprises:
determining, by a running bootloader, a first configuration parameter of a device tree file comprised in the virtual machine image stored in a storage medium, wherein the first configuration parameter is used for configuring a release state of an initial memory filesystem comprised in the virtual machine image after being decompressed at runtime;
loading, by the bootloader, the virtual machine image from the storage medium to the first image running memory based on the first configuration parameter;
loading, by the bootloader, a controller image for the virtual machine controller from the storage medium to a second image running memory pre-allocated for the virtual machine controller, and switching from the bootloader to running the virtual machine controller on the second image running memory; and
creating, by the running virtual machine controller, the virtual machine based on the virtual machine image and executing a virtual machine running instruction to trigger the jump to the kernel entry address of the first image running memory so as to run the virtual machine.

5. The method according to claim 4, wherein the loading, by the bootloader, the virtual machine image from the storage medium to the first image running memory based on the first configuration parameter comprises:
in response to the first configuration parameter configuring the initial memory filesystem to enable release after being decompressed at runtime, loading, by the bootloader, the virtual machine image from the storage medium to the first image backup memory; and
copying, by the running virtual machine controller, the virtual machine image from the first image backup memory to the first image running memory.

6. The method according to claim 5, wherein the copying, by the running virtual machine controller, the virtual machine image from the first image backup memory to the first image running memory comprises:
in response to the virtual machine image stored in the first image backup memory comprising a kernel image, a device tree file, and an initial memory filesystem, copying, by the virtual machine controller, the kernel image from the first image backup memory to a first sub-running memory in the first image running memory, copying the device tree file from the first image backup memory to a second sub-running memory in the first image running memory, and copying the initial memory filesystem from the first image backup memory to a third sub-running memory in the first image running memory.

7. The method according to claim 4, wherein the loading, by the bootloader, the virtual machine image from the storage medium to the first image running memory based on the first configuration parameter comprises:
in response to the first configuration parameter configuring the initial memory filesystem to disable release after being decompressed at runtime, loading, by the bootloader, the virtual machine image from the storage medium to the first image running memory.

8. The method according to claim 7, further comprising:
before running the virtual machine, copying, by the running virtual machine controller, the virtual machine image from the first image running memory to the first image backup memory.

9. The method according to claim 8, wherein the copying, by the running virtual machine controller, the virtual machine image from the first image running memory to the first image backup memory comprises:
in response to the virtual machine image stored in the first image running memory comprising a kernel image, a device tree file, and an initial memory filesystem, copying, by the running virtual machine controller, the kernel image from the first image running memory to a first sub-backup memory in the first image backup memory, and copying the device tree file from the first image running memory to a second sub-backup memory in the first image backup memory.

10. A non-transitory computer-readable storage medium, on which a computer program is stored, wherein the computer program, when executed by a processor, causes the processor to implement a virtual machine running method, the method comprising:
in response to at least one virtual machine being in a running termination state, determining, by a virtual machine controller, a first image running memory and a first image backup memory pre-allocated for the virtual machine, when a virtual machine restart instruction is received;
copying, by the virtual machine controller, a virtual machine image stored in the first image backup memory to the first image running memory; and
executing, by the virtual machine controller, a virtual machine recovery instruction to trigger a jump to a kernel entry address of the first image running memory so as to resume running of the virtual machine.

11. The non-transitory computer-readable storage medium according to claim 10, wherein the copying, by the virtual machine controller, the virtual machine image stored in the first image backup memory to the first image running memory comprises:
in response to the virtual machine image stored in the first image backup memory comprising only a kernel image and a device tree file and an initial memory filesystem in the virtual machine image being stored in the first image running memory, copying, by the virtual machine controller, the kernel image to a first sub-running memory in the first image running memory, and copying the device tree file to a second sub-running memory in the first image running memory.

12. An electronic device, comprising:
a processor; and
a memory for storing instructions executable by the processor;
wherein the processor is configured to read the executable instructions from the memory and execute the instructions to implement a virtual machine running method, the method comprising:
in response to at least one virtual machine being in a running termination state, determining, by a virtual machine controller, a first image running memory and a first image backup memory pre-allocated for the virtual machine, when a virtual machine restart instruction is received;
copying, by the virtual machine controller, a virtual machine image stored in the first image backup memory to the first image running memory; and
executing, by the virtual machine controller, a virtual machine recovery instruction to trigger a jump to a kernel entry address of the first image running memory so as to resume running of the virtual machine.

13. The electronic device according to claim 12, wherein the copying, by the virtual machine controller, the virtual machine image stored in the first image backup memory to the first image running memory comprises:
in response to the virtual machine image stored in the first image backup memory comprising only a kernel image and a device tree file and an initial memory filesystem in the virtual machine image being stored in the first image running memory, copying, by the virtual machine controller, the kernel image to a first sub-running memory in the first image running memory, and copying the device tree file to a second sub-running memory in the first image running memory.

14. The electronic device according to claim 13, wherein the copying, by the virtual machine controller, the virtual machine image stored in the first image backup memory to the first image running memory comprises:
in response to the virtual machine image stored in the first image backup memory comprising a kernel image, a device tree file, and an initial memory filesystem, without the initial memory filesystem in the virtual machine image being stored in the first image running memory, copying, by the virtual machine controller, the kernel image to a first sub-running memory in the first image running memory, copying the device tree file to a second sub-running memory in the first image running memory, and copying the initial memory filesystem to a third sub-running memory in the first image running memory.

15. The electronic device according to claim 12, wherein before in response to at least one virtual machine being in a running termination state, determining, by a virtual machine controller, a first image running memory and a first image backup memory pre-allocated for the virtual machine, when a virtual machine restart instruction is received, the method further comprises:
determining, by a running bootloader, a first configuration parameter of a device tree file comprised in the virtual machine image stored in a storage medium, wherein the first configuration parameter is used for configuring a release state of an initial memory filesystem comprised in the virtual machine image after being decompressed at runtime;
loading, by the bootloader, the virtual machine image from the storage medium to the first image running memory based on the first configuration parameter;
loading, by the bootloader, a controller image for the virtual machine controller from the storage medium to a second image running memory pre-allocated for the virtual machine controller, and switching from the bootloader to running the virtual machine controller on the second image running memory; and
creating, by the running virtual machine controller, the virtual machine based on the virtual machine image and executing a virtual machine running instruction to trigger the jump to the kernel entry address of the first image running memory so as to run the virtual machine.

16. The electronic device according to claim 15, wherein the loading, by the bootloader, the virtual machine image from the storage medium to the first image running memory based on the first configuration parameter comprises:
in response to the first configuration parameter configuring the initial memory filesystem to enable release after being decompressed at runtime, loading, by the bootloader, the virtual machine image from the storage medium to the first image backup memory; and
copying, by the running virtual machine controller, the virtual machine image from the first image backup memory to the first image running memory.

17. The electronic device according to claim 16, wherein the copying, by the running virtual machine controller, the virtual machine image from the first image backup memory to the first image running memory comprises:
in response to the virtual machine image stored in the first image backup memory comprising a kernel image, a device tree file, and an initial memory filesystem, copying, by the virtual machine controller, the kernel image from the first image backup memory to a first sub-running memory in the first image running memory, copying the device tree file from the first image backup memory to a second sub-running memory in the first image running memory, and copying the initial memory filesystem from the first image backup memory to a third sub-running memory in the first image running memory.

18. The electronic device according to claim 15, wherein the loading, by the bootloader, the virtual machine image from the storage medium to the first image running memory based on the first configuration parameter comprises:
in response to the first configuration parameter configuring the initial memory filesystem to disable release after being decompressed at runtime, loading, by the bootloader, the virtual machine image from the storage medium to the first image running memory.

19. The electronic device according to claim 18, the method further comprising:
before running the virtual machine, copying, by the running virtual machine controller, the virtual machine image from the first image running memory to the first image backup memory.

20. The electronic device according to claim 19, wherein the copying, by the running virtual machine controller, the virtual machine image from the first image running memory to the first image backup memory comprises:
in response to the virtual machine image stored in the first image running memory comprising a kernel image, a device tree file, and an initial memory filesystem, copying, by the running virtual machine controller, the kernel image from the first image running memory to a first sub-backup memory in the first image backup memory, and copying the device tree file from the first image running memory to a second sub-backup memory in the first image backup memory.
